(19) United States
(12) Patent Application Publication
(10) Pub. No.: US 2006/0265895 A1
(43) Pub. Date: Nov. 30, 2006

(54) Leveling device

(76) Inventor: Charles Leroy Daugherty, Akron, OH (US)

Correspondence Address: BROUSE MCDOWELL LPA, 388 SOUTH MAIN STREET, SUITE 500, AKRON, OH, 44311, US

(21) Appl. No.: 11/439,868

(22) Filed: May 24, 2006

Related U.S. Application Data
(60) Provisional application No. 60/683,730, filed on May 24, 2005.

(51) Int. Cl. G01D 21/00

(52) U.S. Cl. 33/613

(57) ABSTRACT

A measuring device for rapidly performing repetitive measurements includes a base for supporting the measuring device upright upon a generally horizontal surface and minimizing the tendency of the measuring device to overturn. A generally-rigid template spans a primary distance between first and second terminal ends of the template, said primary distance being suitable to space a building structure apart from an adjacent building structure to establish a desired on-center spacing between those building structures. A marker is also provided to the template and separated a secondary distance from a first terminal end of the template. The secondary distance is the distance a secondary building structure is to be spaced from an adjacent secondary building structure to establish a desired on-center spacing between those secondary building structures.

### CROSS-REFERENCE TO RELATED APPLICATIONS

This application claims the benefit of U.S. Provisional Application No. 60/683,730, filed on May 24, 2005.

### BACKGROUND OF THE INVENTION

1. Field of the Invention

The present invention is directed generally to a measuring device, and more specifically, to a measuring device for repeatedly performing the same or similar measurements of a predetermined distance.

2. Description of Related Art

Traditionally, when framing a wall or other structure being built, support members commonly referred to as “studs” must be spaced from each other such that their centers are located 16 inches apart, as shown in FIG. 1A. The studs can be load bearing, and provide support for the drywall or other wall covering, which gives the wall a finished appearance. To layout the location of the studs, a measuring device such as a tape measure is commonly used to measure from the center of a stud at one end of the wall along a base plate that runs along the length of the wall. A mark is made with a pencil adjacent to the tape measure at 16 inch intervals along the base plate of the wall to indicate the proper location of the remaining studs for that wall.

The tape measure offers a lengthy measuring device that can be adapted to measure various distances, and can be recoiled into a compact package making it easy to carry from job to job. However, the tape measure is flexible and must be uncoiled from within its housing each time a measurement is desired, making it cumbersome for performing repetitive measurements. Further, the tape measure provides no indication whether the base plate on which it rests is level, or whether a stud is plumb.

A conventional level can be used to measure any deviation of a surface from horizontal or vertical orientations. Typically, a level includes one or more spirit vials filled with a liquid and having a bubble therein that is centered between two lines to indicate a perfectly horizontal or vertical orientation of the base plate, depending on the orientation of the vial. Such devices are typically used before the layout of the studs is performed with the tape measure to ensure that the wall is properly configured. Some conventional levels include a graduated scale that can be used as a measuring instrument in addition to a leveling device. However, levels typically have a standard length such as one meter, or one yard, requiring close attention to the measurement scale relative to a stud's location if the level is used to measure a distance of 16 inches on center between adjacent studs. The framer is typically required to observe the stud and measuring scale from a side, which is often inconvenient when the measurements are made close to the floor.

A template can be created to provide a fixed, predetermined spacing between adjacent studs. A block of wood can be cut to the desired length and placed between a stud already fixed in place and the immediately adjacent stud to be installed to create a spacing of 16 inches on center. Once the adjacent stud is fixed in place, the process can be repeated over and over again along the length of the wall to achieve substantially equal spacing between the studs. Although such a block of wood can accurately reproduce the same spacing between adjacent studs along the length of the wall, it is useless for establishing a predetermined spacing between members that are to be spaced a distance other than 16 inches on center. Further, the block of wood provides no measurement scale and no indication of whether a surface deviates from either a horizontal or vertical orientation.

Accordingly, there is a need in the art for a measuring device that can establish a predetermined distance between objects, and can be adapted to repeatedly establish more than one predetermined distance. The measuring device can optionally include features indicating the deviation of a surface from at least one of a horizontal and vertical orientation, and can also optionally include a measuring scale to facilitate measurements other than the one or more predetermined distances.

### BRIEF SUMMARY OF THE INVENTION

According to one aspect, the present invention provides a measuring device for rapidly performing repetitive measurements includes a base for supporting the measuring device upright upon a generally horizontal surface and minimizing the tendency of the measuring device to overturn. A generally-rigid template spans a primary distance between first and second terminal ends of the template, said primary distance being suitable to space a building structure apart from an adjacent building structure to establish a desired on-center spacing between those building structures. A marker is also provided to the template and separated a secondary distance from a first terminal end of the template. The secondary distance is the distance a secondary building structure is to be spaced from an adjacent secondary building structure to establish a desired on-center spacing between those secondary building structures.

According to another aspect, the present invention provides a measuring device for rapidly performing repetitive measurements commonly encountered while building a structure. The measuring device includes a base for supporting the measuring device upon a generally horizontal surface and minimizing the tendency of the measuring device to overturn. A generally-rigid template is coupled to the base and has terminal ends separated by a distance of about 15 15/16 inches, and a marker separated from at least one of the terminal ends of the template a distance of 5 5/16 inches to indicate a measurement of that distance.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1A is a perspective view illustrating an exemplary arrangement of studs along a base plate commonly encountered in constructing a wall;

FIG. 1B is a perspective view of an embodiment of a measuring device in accordance with an embodiment of the present invention for measuring a distance along a base plate;

FIG. 2 is a side view of a measuring device adjacent for repeatedly performing standardized measurements in accordance with an embodiment of the present invention;

FIG. 3A is a cross-sectional view of a measuring device taken along line 3-3 in FIG. 2, wherein the measuring device includes a base extending outwardly away from a template in two directions;

FIG. 3B is a cross-sectional view of a measuring device taken along line 3-3 in FIG. 2, wherein the measuring device includes a base extending outwardly away from a template in one direction; and

FIG. 3C is a cross-sectional view of a measuring device taken along line 3-3 in FIG. 2, wherein the measuring device includes a base extending outwardly away from a template in one direction and having a length approximately the same as the length of the template.

### DETAILED DESCRIPTION OF ILLUSTRATIVE EMBODIMENTS

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

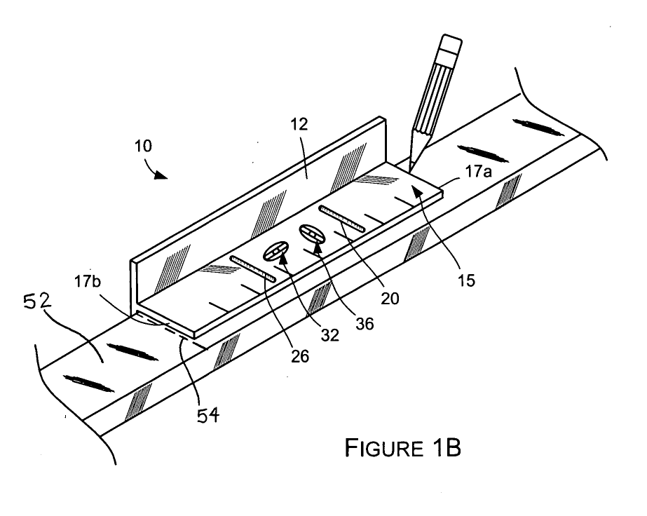

FIG. 2 is a schematic illustration of a measuring device for rapidly performing repetitive measurements, such as spacing adjacent framing studs apart 16 inches on center. An example of a framing stud is a piece of lumber sold as a 2 inch×4 inch piece of lumber having any desired length, wherein said piece of lumber is referred to herein as a “stud” and a “2×4.” Although sold as lumber having the dimensions of 2 inches (thickness) by 4 inches (width), 2×4s are not actually 2 inches by 4 inches. When each 2×4 is first rough sawn from the log, its dimensions are a true 2 inches by 4 inches. But the drying process and subsequent planing of the board reduce it to it actual finished dimensions of 1.5 inches by 3.5 inches.

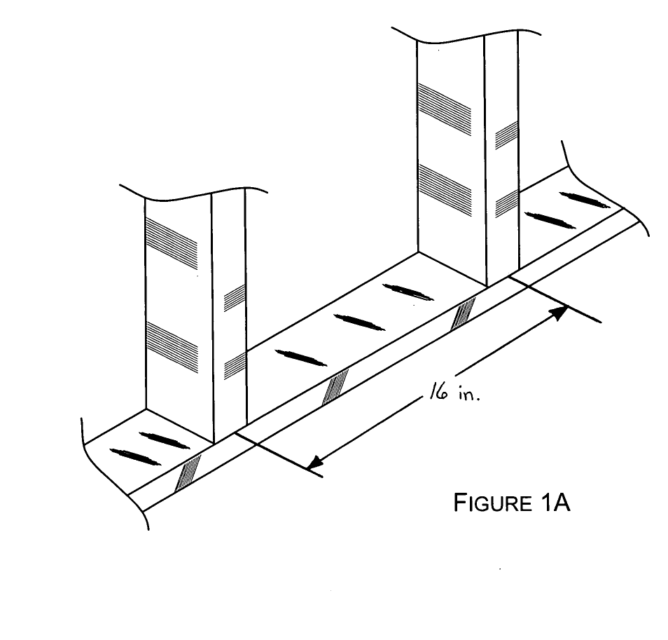

Although the measuring device can be used to repeatedly perform measurements between any objects to be equally spaced, the description herein will focus primarily on adequately spacing framing studs used in the construction of walls, decks and other such structures. As mentioned above, wall studs are spaced 16 inches apart on center. Any on-center spacing, such as the 16 inch on-center spacing of wall studs, requires two studs to be separated a suitable distance apart such that their centers are separated by 16 inches, as shown in FIG. 1A.

The measuring device 10 shown in FIG. 2 includes a base 12 for supporting the measuring device in an upright orientation on a generally-horizontal surface and minimizing the tendency of the measuring device to overturn. The base 12 can be made from any generally-rigid material such as wood, plastic, metal, and any combination thereof, for example. The base 12 can be a generally-planar surface that extends outwardly in at least one direction substantially perpendicular to a planar surface of a template 15 supported by the base 12. Alternate embodiments, however, include any acute, obtuse or right angle between the template 15 and the base 12. Further, embodiments also include a generally-planar template 15 wherein the base 12 is a flat bottom surface of the template 15. Yet other embodiments include a base that is approximately the same width as the template 15, and therefore does not extend outwardly away from the template.

Like the base 12, the template 15 can be made from a generally-rigid material such as wood, plastic, metal, and any combination thereof, for example, that allows the template 15 to retain a substantially-linear shape. Embodiments of the present invention also include a base 12 and template 15 formed from a single piece of material, such as in the case of a plastic-molded measuring device. In FIG. 2, the template 15 is shown as a planar member oriented vertically on its side to extend between two terminal ends 17a, 17b. The template 15 has a length extending a primary distance that is suitable to measure the desired spacing of a building structure such as a stud from an adjacent stud to establish a desired on-center spacing between those two studs. While the length of the template 15 can be any length, as mentioned above, for 16 inch on-center spacing of the adjacent studs, the length of the template is approximately 15 15/16 (which is equal to 15.9375) inches, a length that allows for the ready measurement of a secondary distance as described below. However, other embodiments of the present invention include a template 15 with a length that is any integer multiple of the secondary distance, wherein the integer can be selected from the group consisting of 2, 3, 4, 5, 7, 8, 9 and 10.

A marker 20 is provided to the template and is separated from a terminal end 17a of the template 15 by a secondary distance to indicate a measurement of that distance. The secondary distance can be any distance found between building structures that is to be measured repeatedly and is less than the primary distance. For example, the secondary distance can be the distance between spindles, balusters, and the like. A distance of 5 5/16 (which is equal to 5.3125) inches is a common on-center measurement for such building structures, and is a suitable secondary distance.

The marker 20 can be any indicator that serves to identify the secondary distance from the terminal end 17a. As shown in FIG. 2, the marker 20 is an oval-shaped aperture having a vertical longitudinal axis. The aperture is suitably-sized to permit a pencil lead to extend there through to place a mark on a piece of lumber disposed on the opposite side of the template 15. The mark produced by the pencil lead on the lumber at least partially concealed by the template 15 serves to identify the location where the spindle or other periodically-placed structure should be positioned.

Similarly, a second marker 26 can also be separated from the marker 20 by the secondary distance along the template 15. The second marker 26 can optionally also be an oval-shaped aperture extending through the template 15 that allows the passage of a pencil lead to write on a piece of lumber dispose behind the template 15. Embodiments including the second marker 26 in addition to the marker 20 allow a user to mark two locations on the underlying lumber where adjacent spindles are to be positioned without moving the measuring device 10 between markings. This is due to the equal spacing from the terminal end 17a to the marker 20, and from the marker 20 to the second marker 26.

For embodiments where the primary distance is an integer multiple of the secondary distance, the measuring device 10 offers the flexibility to alternate between ready measurements of different distances. For example, consider a measuring device wherein the primary distance between terminal ends 17a, 17b is 15 15/16 inches and the secondary distance is 5 5/16 inches. This primary distance is three times the secondary distance. In other words, the primary distance is an integer multiple of the secondary distance, wherein the integer is three (3). According to such an arrangement, the one or more markers 20, 26 can be used to measure the separation of building structures such as spindles with 5 5/16 on-center separations and the full length of the template 15 can be used to measure the separation of structures such as studs, requiring a 16 inch on-center separation. Although the full length of the template 15 is not exactly 16 inches to match the on-center spacing of the studs, it is within 1/16 of an inch of the desired measurement, which is an acceptable tolerance for such a measurement. Further, a pencil line marked on the lumber by placing a pencil against the terminal end 17a and dragging the pencil lead on the lumber along the terminal edge 17a as shown in FIG. 1B will be spaced approximately 1/16 of an inch beyond the terminal edge 17a. Thus, the position of the resulting pencil mark is approximately 16 inches from the reference point adjacent to the reference point on the lumber adjacent to the opposite terminal end 17b.

The measuring device 10 can optionally include a graduated scale 29 extending at least partially along a length of the template 15 between the terminal ends 17a, 17b. The scale can be shown as raised indicia protruding outwardly from a surface of the template 15, and can be graduated in any incremental units including, but not limited to 1 inch, ½ inch, ⅓ inch, ¼ inch, ⅛ inch, 1/16 inch, and 1/32 inch, and any combination thereof. The graduated scale can be aligned along an uppermost edge of the template to facilitate measurement of objects adjacent to that edge, provided on one or both planar surfaces of the template 15, at any other location on the measuring device where it can be used to measure an object adjacent to the measuring device, or any combination thereof.

The measuring device 10 can also optionally include a bubble-level vial located at one or more locations on the measuring device 10 for indicating the orientation of at least one surface of the measuring device 10 relative to a reference orientation. For example, a vial 32 can be integrally formed within a plastic molded embodiment of the template 15, and oriented substantially parallel with a lowermost surface 34 of the base 12. Oriented as such, the vial 32 can be used to detect a deviation of an object in contact with the lowermost surface 34 from a horizontal orientation.

Similarly, a vial 36 can optionally be installed within a receptacle in the template 15 and oriented generally perpendicular to the lowermost surface 34 of the base 15. The vial 36, so oriented, can be used to detect a deviation of an object in contact with the lowermost surface 34 from a vertical orientation. The vial 36 for detecting a vertical deviation can be included in combination with, or in lieu of the vial 32 for detecting a deviation from the horizontal orientation.

Regardless of the orientation and location of the vials 32, 36, each one can include a transparent glass or plastic tube, for example, filled with a liquid and including visual indicia relating the orientation of the vial to a deviation from a reference orientation. Some embodiments include two lines 39 that are disposed on opposite sides of a bubble 41 in the liquid when the vial is aligned with the reference direction. Other embodiments include a graduated scale that provides a quantifiable indication of the deviation of the vial from the reference orientation. Yet other embodiments of the vial include a transparent glass or plastic circular vial for indicating the orientation of at least one surface of the measuring device in a two-dimensional plane. Like the tubular vials, the circular vials can optionally include visual indicia allowing an observer to detect, and even quantify in some embodiments, the deviation of the circular vial in the two-dimensional plane. And just as before, one or more circular vials can be provided in any combination with, or in lieu of the one or more tubular vials.

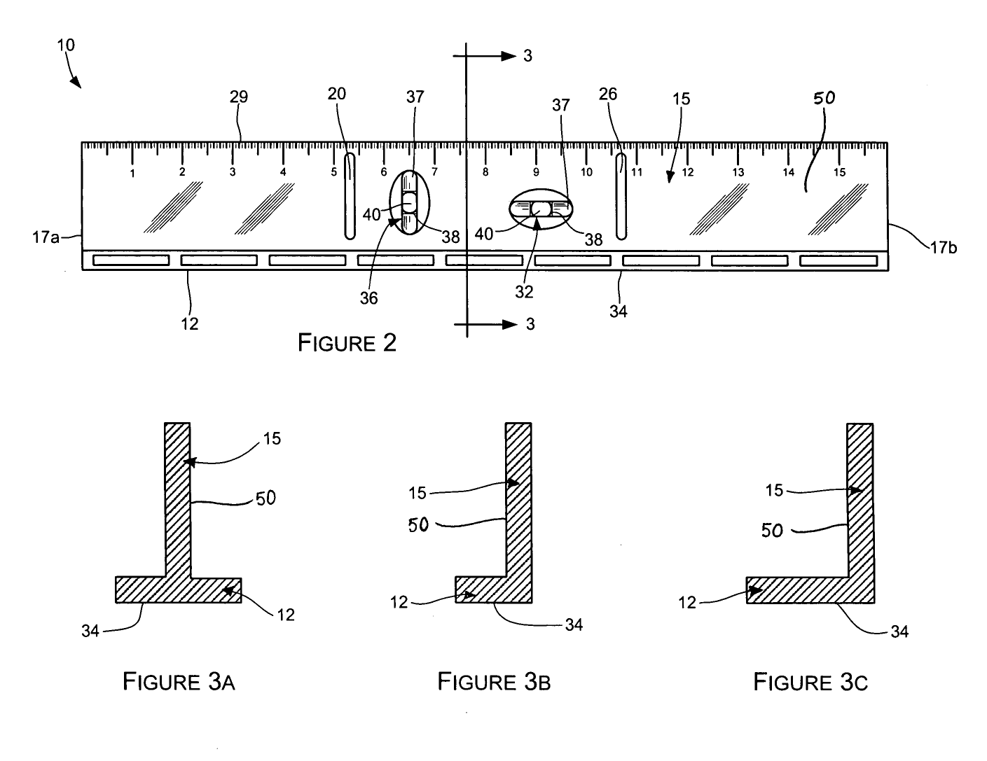

FIGS. 3A, 3B and 3C each show a cross-sectional view of embodiments of the measuring device 10 having different configurations of the base 12 relative to the template 15. In FIG. 3A, the base 12 and the template 15 form a generally T-shaped cross section, where the base extends outwardly in two directions away from the template 15. According to such an embodiment, lumber stock can be placed on end upon the portion of the base projecting outwardly from the template 15, and a reference point on the lumber aligned with one of the terminal ends 17a, 17b of the template 15. A desired measurement can be made and indicated on the lumber itself by inserting a pencil led or other marking tip of a writing instrument through the aperture that forms each marker 20, 26 and placing a pencil mark on the lumber at each secondary distance from the reference point on the lumber. For embodiments where a plurality of markers 20 are provided to the template 15, a pencil mark can be written on the lumber by extending a pencil lead through the aperture forming each marker 20 without moving the measuring device 10 between making each pencil mark.

Using the same measuring device 10 described in the preceding paragraph, a measurement of the primary distance can also be made from a reference point on the lumber. To perform the measurement of the primary distance, at least one terminal end 17a, 17b of the measuring device 10 can be aligned with the reference point on the lumber from which the measurement is to be taken, and the template 15 butted up against the lumber. This reference point may be a terminal end of the lumber, an existing feature such as a wall stud already secured to the lumber, or a mark indicating where a wall stud is to be secured to the lumber. In fact, the reference point can be any point on the lumber from which the primary distance is to be measured. Once at least one of the terminal ends 17a, 17b of the template is properly aligned with the reference point on the lumber, the location of the primary distance from the reference point can be made on the lumber by making a pencil mark adjacent to the terminal end of the measuring device 10 opposite the terminal end aligned with the reference point.

Use of a measuring device 10 having the cross-sectional shape in FIG. 3B will be described for marking the location where a wall stud is to be secured to a base plate. The measuring device 10 is turned on its side such that a planar surface 50 of the template 15 rests approximately flat on the base plate 52, as shown in FIG. 1B. A terminal end 17b can be aligned adjacent to a reference point, which in the present example is a line 54 on the base plate 52 indicating the on-center location on the base plate 52 where a center portion of a wall stud is to be secured. Thus, a stud is to be fastened to the base plate 52 such that the center of the stud rests approximately on the line once the stud is secured to the base plate 52. In the present example, it is also desired to secure a second stud to the base plate 52 such that the second stud is separated from the first stud by 16 inches on center along the base plate 52. Once the terminal end 17b of the template 15 is properly aligned with the line 54, a pencil mark can be made along the opposite terminal end 17a of the template 15 on the base plate 52 to indicate the center location of the second stud. This measurement can be repeated as many times as necessary to make the same measurement along the length of the base plate 52.

The same measuring device 10 can also be used to mark increments along the base plate 52 at the secondary distance. Such would be the case when installing spindles, for example. Once again, the terminal end 17b of the template 15 can be aligned with a reference point on the base plate 52, which again, for the present example will be assumed to be the line 54 on the base plate 52 in FIG. 1B. For the embodiment shown, a pencil line can be marked on the base plate 52 through the marking aperture 26 and again through marking aperture 20, and yet again along the terminal end 17a opposite from the terminal end 17b aligned adjacent to the line 54 on the base plate 52. The pencil lines can be drawn on the base plate 52 by extending the pencil lead through the apertures forming the markers 20, 26. The result of such a measurement is pencil lines on the base plate 52 indicating the secondary distance between the terminal end 17b and the second marker 26, between the second marker 26 and the marker 20, and between the marker 20 and the terminal end 17a. Referring to the exemplary embodiment wherein the secondary distance is about 5 5/16 (in other words, about 5.3125) inches, there are evenly three evenly-spaced measurements made and marked on the base plate 52 from the terminal end 17b to the opposite terminal end 17a, each spaced from the other by about 5 5/16 inches. Again, this is suitable for measuring the on-center measurement of spindles secured to the base plate 52 and separated from each other by 5 5/16 inches on center.

To mark where the next three spindles should be installed, the terminal end 17b of the template 15 can then be aligned with the pencil mark made adjacent to the terminal end 17a in the preceding paragraph. Then, the measurement process can be repeated.

As mentioned elsewhere herein, the secondary distance separating the markers 20, 26 from each other and the terminal ends can be any desired distance, and there can be more or less than two markers 20, 26. Further, embodiments of the present invention can include a primary distance separating the two terminal ends 17a, 17b that is not an exact integer multiple of the secondary distance separating at least one marker 20, 26 from a terminal end 17a, 17b. For such embodiments, the secondary distance is one commonly-encountered measurement while the secondary distance is another commonly encountered measurement in fields such as construction and building. Each of the primary and secondary distances can optionally be independently selected as distances defined by a building code or other regulation, or any other commonly-encountered distances.

FIG. 3B shows a cross-sectional view of an embodiment in which the base and the template form a generally L-shaped cross section, wherein said base 12 extends outwardly in one direction away from the template 15. According to this embodiment, the planar face 50 of the template 15 can again be laid approximately flat on the base plate 52 or other substrate on which the measurements are to be indicated. And just as before, at least one terminal end 17a, 17b of the measuring device 10 can be aligned with a reference point on the substrate from which a measurement is to be taken, and the desired measurement marked on the base plate 52 with a pencil or other marking instrument through one or more markers 20, 26, along the terminal end opposite from the terminal end aligned with the reference point, or a combination thereof. This reference point may be an end of the lumber, an existing feature such as a spindle secured to the lumber, an existing pencil mark, and the like. The reference point can be any point on the lumber from which the primary distance, secondary distance, or both is to be measured.

To indicate a measurement of the secondary distance from the reference point on the lumber, a visual indicator such as a line drawn by a pencil can be written as desired on the lumber through the aperture forming each marker 20, 26, along at least one terminal end 17a, 17b, or a combination thereof. This permits rapid measurement of the primary and secondary distance along the base plate 52. For embodiments where a plurality of markers 20 are provided to the template 15, a line can be written by extending a pencil lead through the aperture forming each marker 20 without moving the measuring device 10 between making each pencil mark on the lumber.

Although the present invention was described above with reference to conducting measurements encountered during construction of a wall, spindles, etc. . . . on a base plate 52, the present invention is not so limited. Further, the marker 20 can be an aperture having any shape suitable to allow a pencil lead or other marking tip of a writing instrument to extend there through to write on a material on which a measurement of the primary distance, secondary distance, or both is desired.

FIG. 3C illustrates yet another embodiment of the measuring device 10, wherein the base 12 extends outwardly in one direction away from the template 15. The length of the base 12 for such an embodiment approaches the height of the template 15 to provide the measuring device 10 with stability when standing upright.

Illustrative embodiments have been described, hereinabove. It will be apparent to those skilled in the art that the above devices and methods may incorporate changes and modifications without departing from the general scope of this invention. It is intended to include all such modifications and alterations in so far as they come within the scope of the appended claims.

What is claimed is:

1. A measuring device for rapidly performing repetitive measurements commonly encountered while building a structure, the measuring device comprising:
a base for supporting the measuring device upon a generally horizontal surface and minimizing the tendency of the measuring device to overturn;
a generally-rigid template having terminal ends separated by a distance of about 15 15/16 inches; and
a marker separated from at least one of the terminal ends of the template a distance of 5 5/16 inches to indicate a measurement of that distance.

2. The measuring device according to claim 1 further comprising a graduated scale extending at least partially along a length of the template between the terminal ends, wherein the scale is graduated in at least one set of increments selected from the group consisting of ⅛ in., 1/16 in., and 1/32 in.

3. The measuring device according to claim 1 further comprising a bubble-level vial for indicating the orientation of at least one surface of the measuring device relative to a reference orientation.

4. The measuring device according to claim 3, wherein the bubble-level vial is a tubular vial for indicating the orientation of the at least one surface of the measuring device relative to a horizontal orientation.

5. The measuring device according to claim 3, wherein the bubble-level vial is a tubular vial for indicating the orientation of the at least one surface of the measuring device relative to a vertical orientation.

6. The measuring device according to claim 3, wherein the bubble-level vial is a circular vial for indicating the orientation of the at least one surface of the measuring device in a two-dimensional plane.

7. The measuring device according to claim 1 further comprising a plurality of bubble-level vials for indicating the orientation of at least one surface of the measuring device relative to a plurality of different reference orientations.

8. The measuring device according to claim 7, wherein the plurality of bubble-level vials include a vial for indicating the orientation of the at least one surface of the measuring device relative to a horizontal orientation, and at least one vial for indicating the orientation of the at least one surface of the measuring device relative to a vertical orientation.

9. The measuring device according to claim 1, wherein the base is a platform that extends outwardly in at least one direction substantially perpendicular to a surface of the template.

10. The measuring device according to claim 1, wherein the base and the template form a generally T-shaped cross section when viewed adjacent to a terminal end of the template.

11. The measuring device according to claim 1, wherein the base and the template form a generally L-shaped cross section when viewed adjacent to a terminal end of the template.

12. The measuring device according to claim 1, wherein the distance between the terminal ends of the template is exactly 15 15/16 inches.

13. The measuring device according to claim 1, wherein a marker is separated from each terminal end of the template by a distance of 5 5/16 inches to indicate a measurement of that distance from each of the terminal ends.

14. The measuring device according to claim 1 further comprising one or more additional markers periodically spaced along a length of the template inward of the terminal ends in intervals of 5 5/16 inches.

15. The measuring device according to claim 1, wherein the distance between the terminal end and the marker is measured along the template in a direction that is generally-parallel to the base.

16. A measuring device for rapidly performing repetitive measurements, the measuring device comprising:
a base for supporting the measuring device upright upon a generally horizontal surface and minimizing the tendency of the measuring device to overturn;
a generally-rigid template spanning a primary distance between first and second terminal ends, said primary distance being suitable to space a building structure apart from an adjacent building structure to establish a desired on-center spacing between those building structures; and
a marker provided to the template and separated a secondary distance from a first terminal end of the template, wherein the secondary distance is the distance a secondary building structure is to be spaced from an adjacent secondary building structure to establish a desired on-center spacing between those secondary building structures.

17. The measuring device according to claim 16, wherein the primary distance is about 15 15/16 inches.

18. The measuring device according to claim 16, wherein the secondary distance is about 5 5/16 inches.

19. The measuring device according to claim 16 further comprising at least one bubble-level vial for indicating the orientation of at least one surface of the measuring device relative to a reference orientation.

20. The measuring device according to claim 16, wherein the primary distance is an integer multiple of the secondary distance, wherein the integer is at least one integer selected from the group consisting of 2, 3, 4, 5, 6, 7, 8, 9 and 10.
